(19) United States
(12) Patent Application Publication
(10) Pub. No.: US 2016/0061152 A1
(43) Pub. Date: Mar. 3, 2016

(54) SENSOR FOR A COMPONENT OF A MOTOR VEHICLE

(71) Applicant: Valeo Systemes de Controle Moteur, Cergy Saint Christophe (FR)

(72) Inventors: Nicolas Martin, Maisons-Laffitte (FR); Grégory Hodebourg, Sartrouville (FR)

(73) Assignee: VALEO SYSTEMES DE CONTROLE MOTEUR, Cergy Saint Christophe (FR)

(21) Appl. No.: 14/841,896

(22) Filed: Sep. 1, 2015

(30) Foreign Application Priority Data
Sep. 1, 2014 (FR) 1458165

(51) Int. Cl. F02M 25/07; G05D 7/06; F16K 11/02; G01B 7/30; F02D 41/00

(52) U.S. Cl. CPC F02M 25/0793; G01B 7/30; F02M 25/0771; F02M 25/0796; F02D 41/0077; F16K 11/02; G05D 7/0635

(57) ABSTRACT

A sensor for a component of a motor vehicle, said sensor being capable of measuring a physical property of a component with a first sensitivity when the physical property is in a range of high sensitivity, with a second sensitivity when the physical property is in a range of low sensitivity, the first sensitivity being greater than the second sensitivity.

The invention relates in particular to a fluid control unit for a valve, in particular for an engine control valve, equipped with a proportioning flap and a diverter flap.

The proportioning flap is generally able to pivot in a first port in order to cause the cross section for the passage of the gases to vary, and the diverter flap is designed in order to pivot between a first closed position of a second port and a second closed position of a third port. Such a valve may, for example, be positioned in an EGR gas loop (Exhaust Gas Recirculation) downstream of a cooler, the proportioning flap regulating the rate of flow of the gases in said loop, and the diverter flap being able to close either an access port to said cooler or a diversion channel bypassing this cooler. The valve may comprise a proportioning flap and a diverter flap operated by an improved actuating mechanism for said flaps.

Patent US2010/0199957 describes an EGR valve positioned upstream of a cooler, said valve having a first proportioning flap intended to control the rate of flow of the gases in the EGR loop and a second diverter flap positioned downstream of said proportioning flap making it possible either to cause the gases to pass through the cooler, or to divert the gases into a diversion channel in order to bypass said cooler. The principal characterizing feature of said valve is that it implements an actuating mechanism which is common to the two flaps. The principal disadvantage presented by such a mechanism is that it comprises a large number of specially shaped components, interacting with each other in a complex manner, in so doing multiplying the risks of malfunctioning, or even breakdowns.

In a manner known per se, for the purpose of controlling the valve, a position sensor is used in order to obtain the position of the actuating mechanism in order to permit the control of the valve.

The invention aims to propose a sensor which permits a physical quantity to be measured with an optimized sensitivity.

The invention thus relates to a sensor, in particular for a component of a motor vehicle, said sensor being capable of measuring a physical property of a component:
with a first sensitivity when the physical property is in a range of high sensitivity,
with a second sensitivity when the physical property is in a range of low sensitivity, the first sensitivity being greater than the second sensitivity.

Thanks to the invention, it is possible to select the one or more ranges in which it is desirable to obtain measurements with a high sensitivity, for example where a command must be based on precise measurements, and the one or more other ranges in which it is not necessary to have high sensitivity, for example where the command does not call for precise measurements. In other words, the invention places emphasis, as regards their precision, on measurements in a certain range and discounts the measurements in another range. The sensor can thus be applied more effectively to the ranges of interest than, for example, a sensor which operates by providing a constant sensitivity.

In one illustrative embodiment of the invention, the sensor is arranged to generate two ranges of high sensitivity and one range of low sensitivity.

The ranges of high sensitivity are preferably situated to either side of the range of low sensitivity.

The ranges of high sensitivities may exhibit the same measurement sensitivity, or, as a variant, at least one of the ranges of high sensitivity may exhibit a sensitivity that is greater than that of the other range of high sensitivity.

If desired, the width of the ranges of high sensitivity may be greater than that of the range of low sensitivity.

As a variant, the width of at least one of the ranges of high sensitivity may be smaller than that of the range of low sensitivity.

Advantageously, the value of the high sensitivity is at least two times, and in particular at least four times higher than that of the low sensitivity.

The sensor may be arranged to deliver a signal of the analog type.

For example, the sensor may be so arranged as to produce an output signal which is an electrical voltage.

As a variant, the sensor may be arranged to produce signals of the digital type.

The signal produced by the sensor preferably follows a linear path in the interior of the measurement ranges.

In one illustrative embodiment of the invention, the physical property measured by the sensor is a position of an actuating device.

For example, the physical property measured by the sensor is an angular position.

If necessary, the angular position may vary between two extremes comprised between 0 and 360°.

As a variant, the physical property measured by the sensor may be a linear position.

The invention also has as its objet a fluid control unit for a valve having at least three ports, in particular for a motor vehicle, the unit comprising:
a mobile metering means arranged for the selective opening or closing of a first of the three ports,
a mobile diverting means arranged for the selective closing of a second or a third of the three ports,
an actuating device for the two means,
at least one sensor capable of measuring a physical property of the actuating device:
   i. with a first sensitivity when the physical property is in a range of high sensitivity,
   ii. with a second sensitivity when the physical property is in a range of low sensitivity, the first sensitivity being greater than the second sensitivity.

Preferentially, the unit includes first and second ranges of high sensitivity, and the unit is characterized in that:
the first range of high sensitivity extends from the position of the actuating device corresponding to the position of maximum opening of the metering means, as far as the position corresponding to the closed position of the metering means, the diverting means being stationary in this range and closing the second port,
the second range of high sensitivity extends from the position of the actuating device corresponding to the closed position of the metering means as far as the position corresponding to the position of maximum opening of the metering means, the diverting means being stationary in this range and closing the third port,
the range of low sensitivity corresponds to the range in which the metering means is in the closed position of the first port, the diverting means passing from the closed position of the second port to the closed position of the third port, this range of low sensitivity preferably being between the two ranges of high sensitivity.

In one example of the implementation of the invention, the actuating device includes at least one mobile actuating wheel in rotation for the joint actuation of the metering means and of the diverting means.

The invention also relates to a valve including the fluid control unit as described above.

The invention also relates to a method for the measurement of a physical property of a component, said method including the following stages:
measuring the physical property with a first sensitivity when the physical property is in a range of high sensitivity,
measuring the physical property with a second sensitivity when the physical property is in a range of low sensitivity, the first sensitivity being greater than the second sensitivity.

In one example of the implementation of the invention, the measured physical property is an angular position.

For example the measured physical property is a position of a valve.

Advantageously, an individual calibration of the characterizing features of the sensor is performed in order to ensure that the voltage produced for each of the positions corresponding to one extreme of the different defined ranges of sensitivity is constant.

The invention will be better understood with reference to the Figures.

The fluid control unit described above may include:
a mobile metering means arranged for the selective opening or closing of a first of the three ports,
a mobile diverting means arranged for the selective closing of a second or a third of the three ports,
an actuating device for the two means,
   the unit being arranged in such a way that, in a first operating range, the actuating device actuates the diverting means while leaving the metering means stationary.

Advantageously, the cross section of the opening into the first port, at the level of the metering means, is thus maintained at a constant level during actuation of the diverting means. The rate of flow of the fluid circulating in the valve is thus maintained at a constant level during the selection of one of the second and third ports.

Within the meaning of the present application, the expression closing is understood to denote total closing or quasi-total closing. Total closing corresponds to closing in which no fluid passes. Quasi-total closing corresponds to closing in which a residual flow may occur, in particular because of a working clearance of the metering means or the diverting means.

The valve may include:
a body delimiting a first port, a second port and a third port, the ports discharging into a common interior space,
a mobile metering means arranged to close the first port,
a mobile diverting means arranged for the selective closing of the second or the third of the three ports,
an actuating device that is common to the two means,
   the valve being arranged in such a way that, in a first operating range, the actuating device actuates the diverting means while leaving the metering means stationary.

Preferably, the valve may be positioned in an EGR loop comprising a cooler and a diversion channel bypassing said cooler, the metering means regulating the gas flow in said EGR loop and the diverting means closing either a port providing access to said cooler, or said diversion channel.

The EGR loop may be a high-pressure loop or a low-pressure loop.

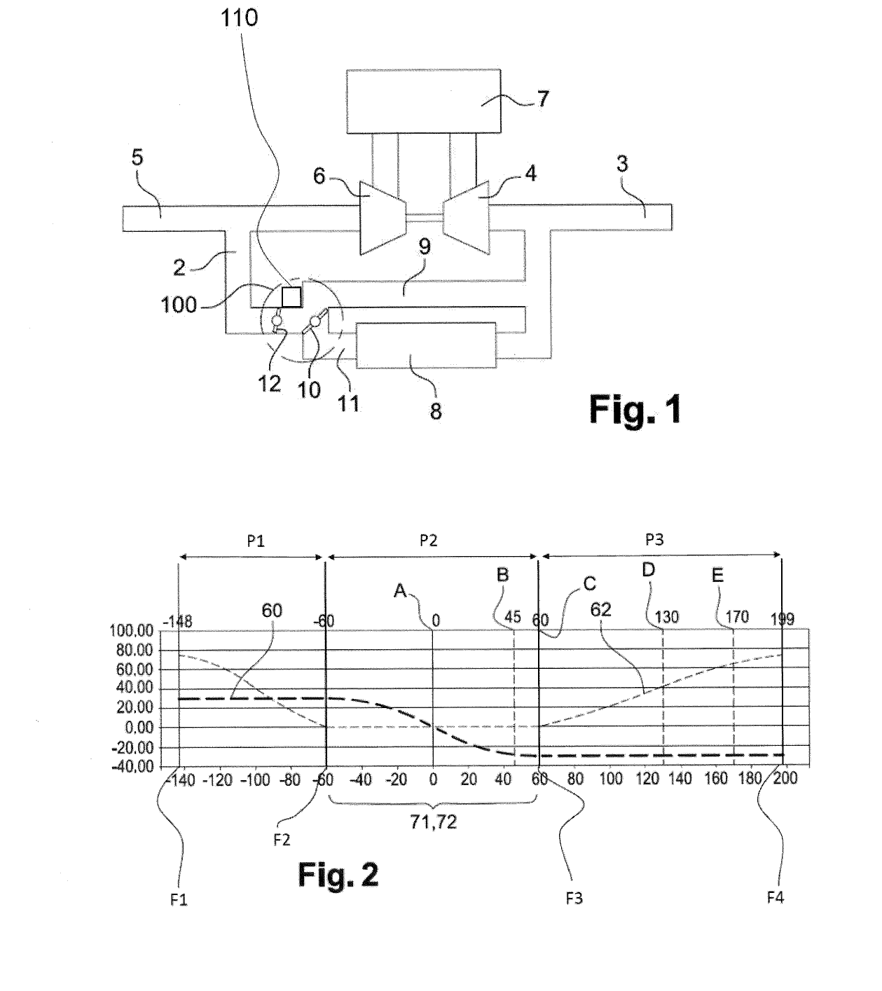

A detailed description of a preferred embodiment of a fluid control unit for a valve according to the invention is provided below, with reference to FIGS. 1 to 12.

FIG. 1 is a schematic view of a low-pressure EGR loop in which the valve may be used,

FIG. 2 is a graph showing the angular position of the proportioning flap and of the diverter flap depending on the angular position of the actuating wheel,

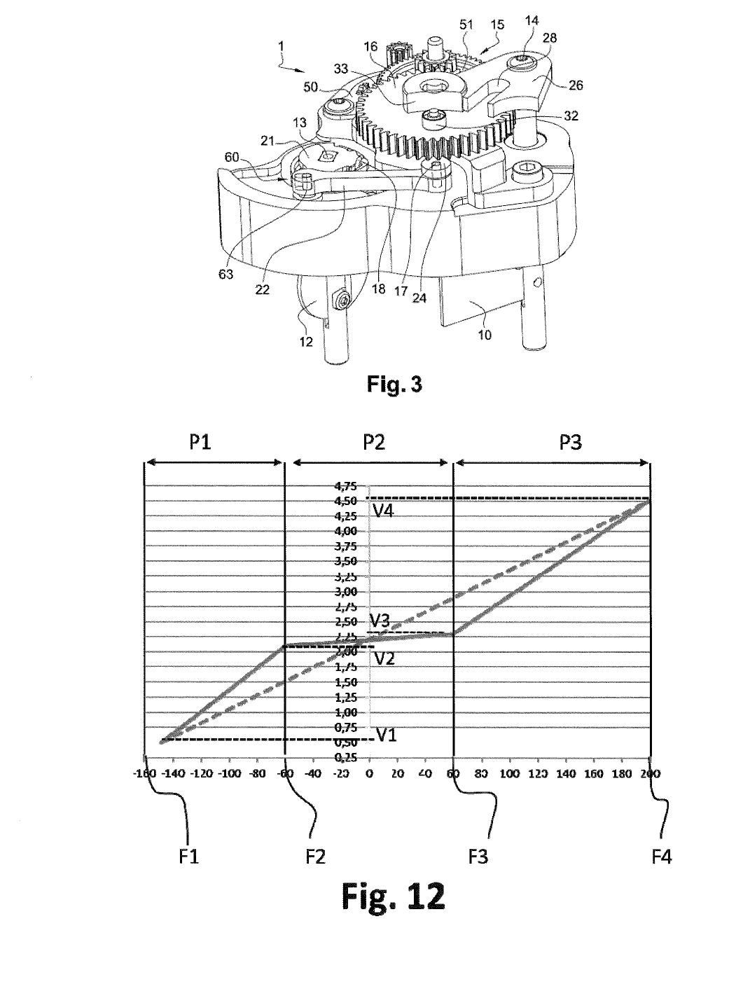

FIG. 3 is a view in perspective of the fluid control unit according to the invention,

FIGS. 4, 6, 8 and 10 are four views from below of the fluid control unit for a valve according to the invention at four different stages of rotation of the actuating wheel, in the same direction of rotation from the resting position of the flaps of the fluid control unit,

FIGS. 5, 7, 9 and 11 are four views from above, representing the fluid control unit according to FIGS. 5, 6, 8 and 10 respectively, and

FIG. 12 compares the response curves of a sensor according to the state of the art and of a sensor according to the invention.

With reference to FIG. 1, a valve 100 according to the invention is a low-pressure EGR valve positioned in an EGR loop linking an exhaust line 3 downstream of a turbine 4 to a fresh air admission circuit 5 upstream of a compressor 6, the turbo compressor 4, 6 being connected conventionally, furthermore, to an internal combustion engine 7. The EGR loop comprises the valve 100, a cooler 8 for the EGR gases and a diversion channel 9 for said gases originating upstream of said cooler 8 and discharging into an outlet port 2 of the EGR loop, downstream of said cooler 8. The valve 100 is a valve with three ports comprising a body delimiting the ports 2, 9 and 11, said three ports discharging into a common interior space. The valve 100 has a fluid control unit 1 according to the invention. The fluid control unit 1 comprises a proportioning flap 12 rotatably mounted about an axis 13, said proportioning flap 12 regulating the cross section for the passage of the gases into the port 2 and thus into the EGR loop. The fluid control unit 1 likewise comprises a mobile diverter flap 10 in rotation about an axis 14, between a closed position of the diversion channel 9 and a closed position of a passage 11 for access to the cooler 8. The fluid control unit 1 in addition comprises a common actuating device 15 for controlling the movement in rotation of the two flaps 10, 12.

FIG. 3 represents a view in perspective of the fluid control unit 1 for the valve 100 according to the invention. In the example under consideration, the common actuating device 15 for the two flaps 10, 12 includes an actuating wheel 16, with the ability to be set in rotation in both directions by means of an electric motor 50 engaging with an intermediate gear 51, the intermediate gear 51 engaging with the actuating wheel 16. The direction of rotation of said wheel 16 is dictated by the closed position that it is wished to impart to the diverter flap 10. This wheel 16 controls both the pivoting of the proportioning flap 12 and the pivoting of the diverter flap 10 according to a synchronized cinematic.

In the example under consideration, the actuating device 15 comprises a torsion spring 18, in order to return the two flaps 10, 12 to a resting position.

The actuating device 15 comprises in addition a guiding means 22, 24 capable of actuating the proportioning flap 12. The actuating device 15 includes in addition an interface unit 21 rigidly coupled to the proportioning flap 12. This interface unit 21, in the example under consideration, is a crank mounted at one extremity of the axis 13 of the flap 12 and interacting with the guiding means 22, 24 in order to permit pivoting of the proportioning flap 12.

In the example described here, the guiding means 22, 24 includes a delaying device 60. In the example described here, the delaying device 60 is provided at the extremity of the guiding means 22 interacting with the interface unit 21. The delaying device 60 includes an oblong cavity, and the interface unit 21 includes a pin 63 extending into the cavity in order to permit the pin to slide in the interior of the cavity. The guiding means 22, 24 includes a first lever 24 and a second lever 22 that are articulated with one another in a rotational manner, via a common extremity, the first lever 24 comprising another extremity interacting via a pivot 17 with the actuating wheel 16, and the second lever 22 including the delaying device 60. The second lever 22 and the oblong cavity extend on the same axis.

In the example described here, the actuating device 15 comprises in addition an actuating system for the diverter flap 10. This actuating system comprises a guiding part 32, an interface component 26 and a retaining part 33 for the interface component 26. The retaining part 33 and the guiding part 32 are rigidly coupled to the actuating wheel 16. The interface component 26 is rigidly coupled to the diverter flap 10. The guiding part 32 interacts with the interface component 26 in order to cause the diverter flap 10 to pivot.

The actuating wheel 16 interacts with the guiding part 32 via a first face of the wheel 16 and the actuating wheel 16 faces towards the common extremity of the first 24 and the second 22 levers of the guiding means 22, 24 via a face opposite the first face of the wheel 16.

The interface component 26, the guiding part 32 and the retaining part 33 are situated facing towards a first face of the actuating wheel 16. The crank 21 and the levers 24 and 22 are situated facing towards a second face, opposite the first face, of the actuating wheel 16.

A blind groove 28 is arranged in the interface component 26 and the guiding part 32 rests in the blind groove 28 at least when the diverter flap is in the resting position. When the guiding part is resting in the blind groove 28, it thus exerts, under the effect of a rotation of the actuating wheel 16, a pressure on the interface component 32 in order to actuate the diverter flap 10.

The retaining part 33 and the interface component 26 comprise complementary surfaces, such that the interaction between these complementary surfaces retain the interface component 26 in position in the course of the displacement of the guiding part 32, while the diverter flap 10 closes the diversion channel 9 or the passage 11.

The fluid control unit 1 of the valve 100 is illustrated in a configuration in which the angular position of the actuating wheel 16 is in the order of 130°. This position is indicated in FIG. 2 by the letter D. In this angular position, the diverter flap 10 is in the closed position of the port 11 and the proportioning flap 12 has an angular position in the order of 40°, that is to say said flap 12 opens the port 2 partially.

FIG. 2 illustrates:
on the vertical axis, the angular position of the proportioning flap 12 and of the diverter flap 10,
on the horizontal axis, the angular position of the actuating wheel 16.

Curve 60 illustrates the angular position of the diverter flap 10, and curve 62 illustrates the angular position of the proportioning flap 12.

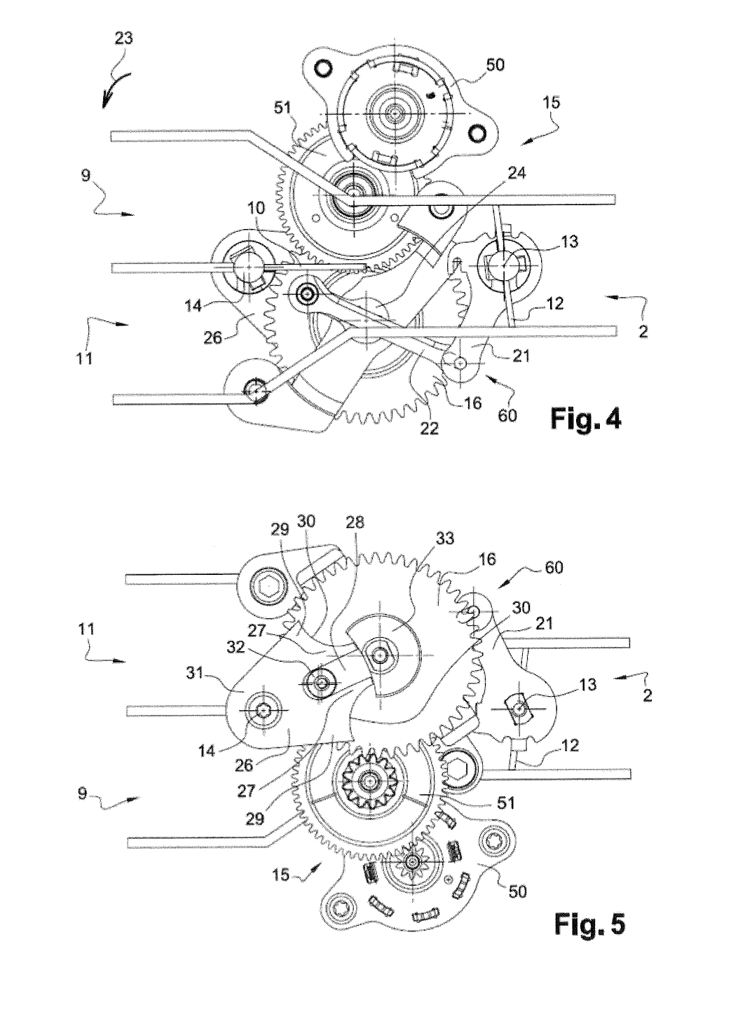

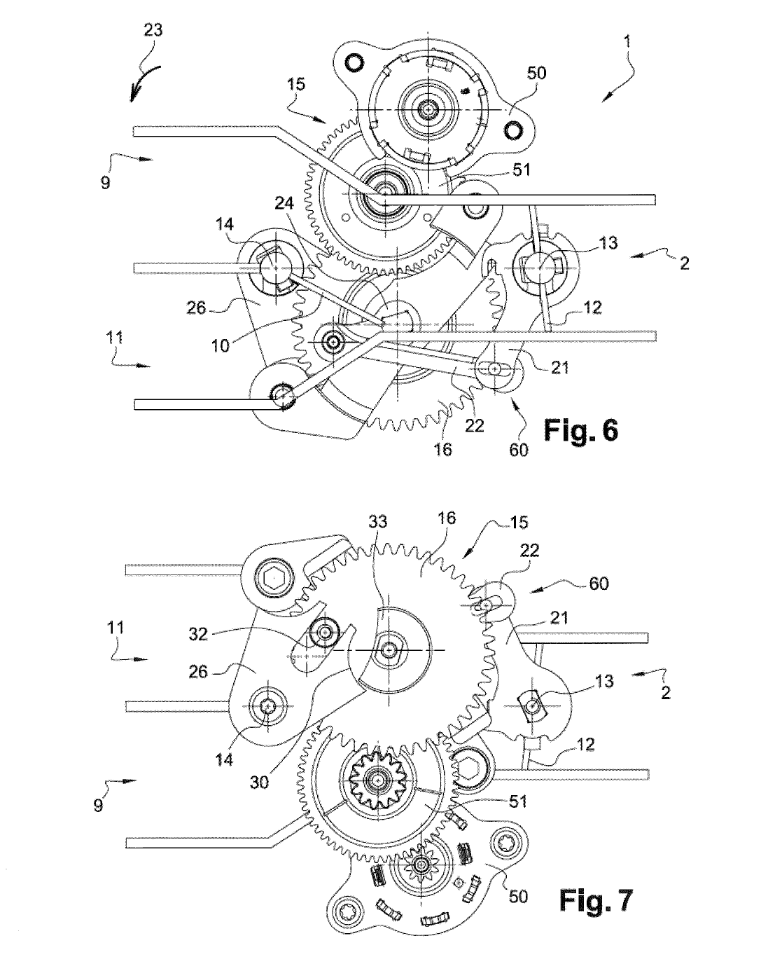

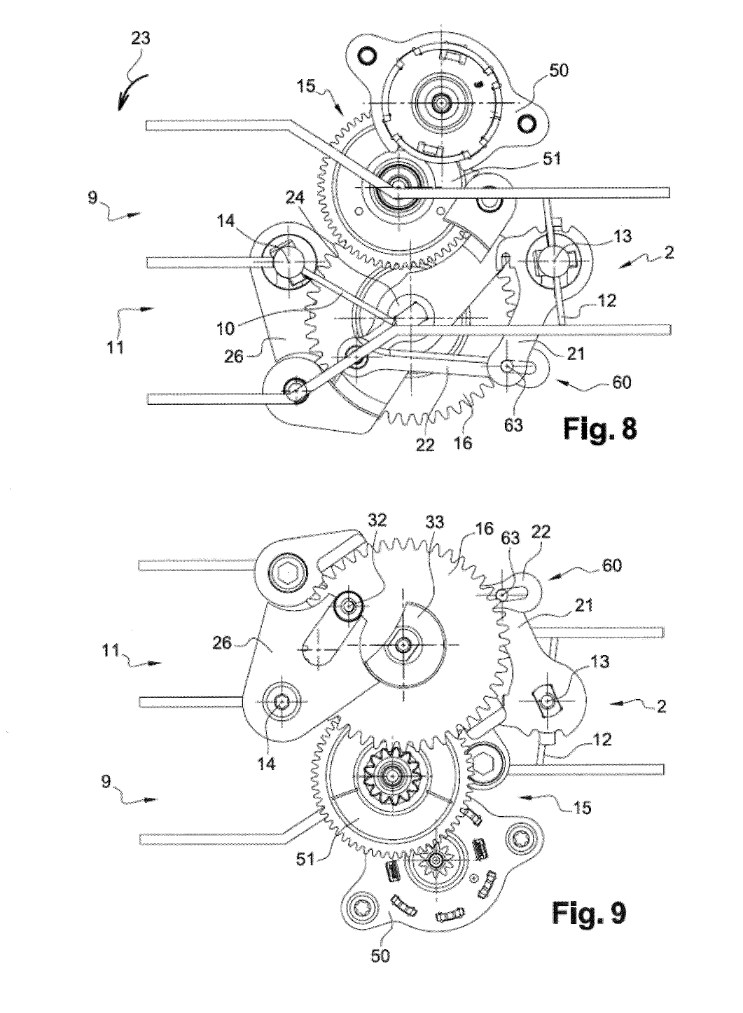

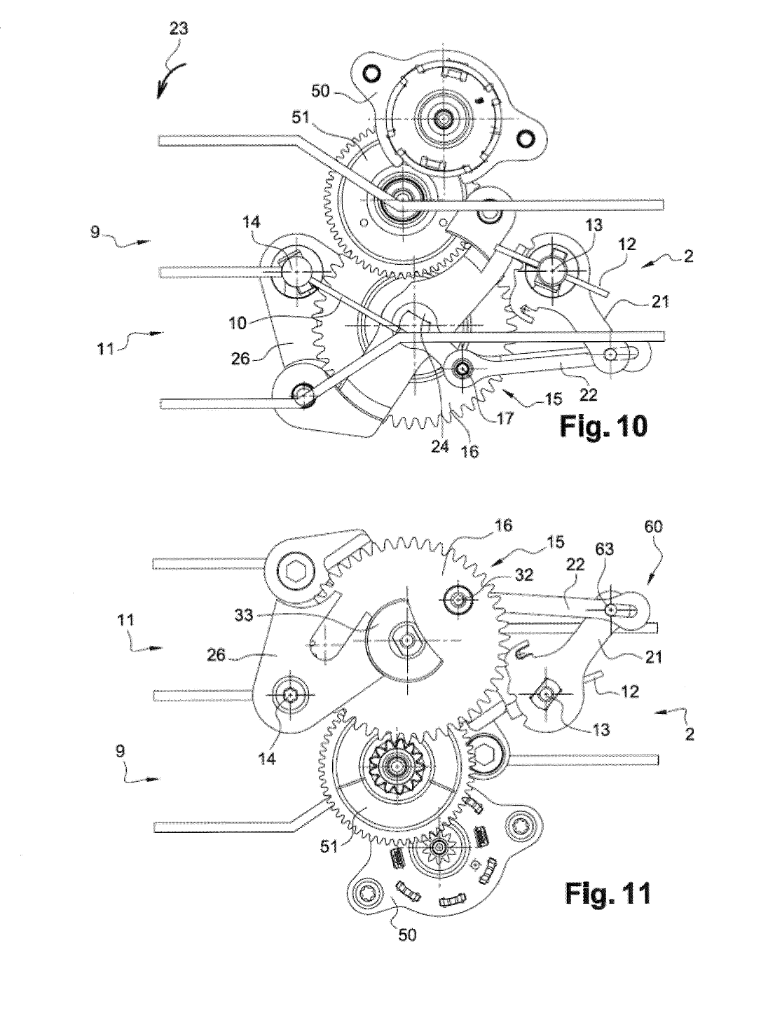

The different angular positions of the proportioning flap 12 and of the diverter flap 10 illustrated in FIGS. 3 to 11 are thus visible on the curves in FIG. 2, namely:
the resting position A as illustrated in FIGS. 4 and 5, for an angular position of 0° of the actuating wheel 16,
the position B as illustrated in FIGS. 6 and 7, for an angular position of 45° of the actuating wheel 16,
the position C as illustrated in FIGS. 8 and 9, for an angular position of 60° of the actuating wheel 16,
the position D as illustrated in FIG. 3, for an angular position of 130° of the actuating wheel 16,
the position E as illustrated in FIGS. 10 and 11, for an angular position of 170° of the actuating wheel 16.

In the resting position A, the proportioning flap 12 is in the closed position of the output port 2 of the EGR loop (angular position of 0°), and the diverter flap 10 is in a position in which it closes neither the port 9 nor the port 11 (angular position of 0°). In this resting position A, the actuating wheel 16 has an angular position of 0°.

Starting from the resting position A of the actuating device 15, the rotation of the actuating wheel 16 in a first direction (in order to reach 199°) or in a second direction opposite the first direction (in order to reach) −148° will result in:
pivoting of the proportioning flap 12, still in the same direction, and indicated by a maximum positive angular position in the order of 75°,
pivoting of the diverter flap, in order to reach −30° or 30° respectively.

In other words, regardless of the direction of rotation of the wheel 16 from the resting position A, the proportioning flap 12 pivots, still in the same direction, with an amplitude close to 75° from the position in which it closes the port 2, and the diverter flap 10 pivots in a first direction or in a second direction, in order to close one or other of the ports 9 and 11.

Curves 60 and 62 define a first operating range 71, in which the actuating device 15 actuates the diverter flap 10 while leaving the proportioning flap 12 stationary. In fact, in this operating range 71, the proportioning flap remains in the closed position of the port 2 (angular position in the order of 0°) and the diverter flap 10 pivots from an angular position in the order of 30° to −30°. The diverter flap 10 does not close either the port 9 or the port 11 solely in the first operating range 71. In other words, outside the first range 71, the diverter flap 10 closes one of the ports 9 and 11. Outside the first range 71, the proportioning flap does not close the port 2 and pivots in order to cause the cross section for the passage of the fluid into the port 2 to vary.

In the first operating range 71, the actuating wheel rotates with an amplitude close to 120°, and the resting position A is included in the first operating range 71.

In the resting position A, the diverter flap is in a median position in which each of the ports 9 and 11 is open to its maximum extent.

Position B is included in the first operating range 71. In this position B, the proportioning flap 12 is in a closed position of the port 2, and the diverter flap is in a position in which the port 11 has a cross section for the passage that is smaller than that of the port 9.

Position C is included in the first operating range 71. This position is that which is adopted by the actuating device immediately prior to exiting from the first operating range 71. In this position C, the diverter flap 10 is almost entirely in the closed position of the port 11, and the proportioning flap 12 is still in the closed position of the port 2.

Positions D and E are outside the first operating range 71. In these positions, the proportioning flap opens the port 2, and the diverter flap closes the port 11.

FIGS. 4, 6, 8, 10 (for the views from below) and respectively 5, 7, 9 and 11 (for the views from above) depict the fluid control unit 1 at four different stages, starting from the resting position A in FIG. 4 in order to arrive at position E in FIG. 11, the actuating wheel 16 rotating in the direction indicated by the arrow 23 in FIGS. 6, 8 and 10. This direction of rotation is that which is adopted when the actuating wheel 16 is observed in views from below.

The rotation of the actuating wheel 16 results in the rotation of the lever 24 and the guiding part 32.

The actuating wheel 16, the lever 22, the crank 21, the lever 24 and the proportioning flap 12 are positioned in the space and are arranged in relation to one another, in such a way that the rotation of the actuating wheel 16, in one direction or in the other, causes, by means of the lever 22, a displacement of the lever 22 relative to the crank 21 in the same direction, having as its effect a displacement of the oblong cavity relative to the pin 63.

The diverter flap 10 is moved in rotation by means of a mechanism of the “Maltese cross” type, the principle of which is based on the discontinuous rotation of an object in the form of a Maltese cross by means of the continuous rotation of an actuator interacting with said objet. In the context of the invention, the object in the form of a Maltese cross is the interface component 26, which has been integrated with the flap 10. This interface component 26 comprises two parallel arms 27 between them providing the groove 28 defining a guide path, as will be seen below, and two lateral protrusions 29, each of said protrusions 29 being positioned to either side of the longitudinal axis of the groove 28.

An arm 27 and a protrusion 29 positioned on the same side in relation to the longitudinal axis of the groove 28 are connected to one another via a surface in the form of the arc of a circle 30. The interface component 26 has a base plate 31 that is aligned with the longitudinal axis of the groove 28, the axis connecting together the two protrusions 29 separating said base plate 31 and the two arms 27. In this way, each arm 27 has one extremity that is implanted in the base plate 31, and another extremity which is free. The flap 10 has an axis of rotation 14 allowing it to pivot between the two closing positions of the two ports 9, 11, the interface component 26 being rigidly attached to one extremity of the flap 10 by means of said base plate 31. More precisely, the interface component 26 is attached to the flap 10 in such a way that the base plate 31 of the interface component 26 is traversed by the axis of rotation 14 of the flap 10. The rotation of the interface component 26 thus results simultaneously in the rotation of the flap 10 about its axis of rotation 14 and the interface component 26 with the same angle.

The guiding part 32 in this case is a drive pin attached to the actuating wheel 16, on which a ball bearing interacts in the example described. The drive pin 32 is cylindrical, for example, and is positioned on the periphery and emerges from the plane of the actuating wheel 16 in a perpendicular direction.

The retaining part 33 in this case is a fraction of another wheel that is coaxial with the actuating wheel 16 and is integral with the latter. This other wheel 33 is disposed in the central zone of the actuating wheel 16. The other wheel 33 emerges from the plan of the wheel 16 in a perpendicular direction, and thus creates an excess thickness. The transverse section of the other wheel 33, which is perpendicular to its axis of rotation, exhibits a circular contour over more than half of its circumference, as well as a recess delimited by a curved section connecting the partial circular contour in order to close said section.

FIGS. 4 and 5 depict the actuating system 15 while the flaps 10, 12 are in the resting position A.

The drive pin 32 of the actuating wheel 16 is positioned at the base of the groove 28. The two arms 27 of the interface component 26 then occupy the hollow that is left vacant by the retaining part 33, their free extremity scraping the curved section of said retaining part 33.

The levers 22 and 24 are in alignment. The proportioning flap 12 is returned to the closed position of the port 2 by the return spring 18. The pin 63 is situated at one extremity of the cavity, a first inner edge of the cavity being at a distance from the pin 63 and a second inner edge being in proximity to the pin 63. The pin 63 and the second inner edge may leave a clearance in order to permit the adjustment of the parts during installation of the unit 1.

The diverter flap 10 is in a position providing maximum opening of the ports 9 and 11.

With reference to FIGS. 6 and 7, when the wheel 16 is set in rotation in the direction indicated by the arrow 23, when viewed from below, from the resting position, the drive pin 32 causes the interface component 26 and thus the diverter flap 10, which is integral with it, to be set in rotation by exerting a pressure on one of the two arms 27 bordering the groove 28. The rotation of the actuating wheel 16 in addition sets the lever 24 in rotation, which causes the displacement of the lever 22. The pin 63 slides in the interior of the oblong cavity 62 in such a way that the crank 21 remains stationary. As a consequence, the proportioning flap 12 remains in the closed position of the port 2.

With reference to FIGS. 8 and 9, the flap 10 reaches the closed position of the port 11, and the proportioning flap 12 remains in the closed position of the port 2. The pin 63 rests against the first inner edge of the cavity. The crank 21 remains stationary, and the proportioning flap 12 remains in the closed position of the port 2.

With reference to FIGS. 10 and 11, once the diverter flap 10 has arrived in its closed position of the port 11, the actuating wheel 16 may continue its rotation in such a way that a segment 30 in the form of the arc of a circle of the interface component 26 bears against the retaining part 33, and more specifically against the external surface of the cylindrical portion of said part 33. This retaining part 33 helps to maintain the diverter flap 10 in a closed position of the port 11, by bearing against a segment 30 in the form of the arc of a circle of the interface component 26. The rotation of the actuating wheel 16 continues to produce the rotation of the lever 24, which causes the displacement of the lever 22. The pin 63 causes the crank 21, and thus the proportioning flap 12, which is integral with it, to be set in rotation by exerting a pressure on the first inner edge of the cavity. The proportioning flap 12 is illustrated here when it has an angular position in the order of 70°.

The rotation of the actuating wheel 16 may continue, still in the same direction, until the proportioning flap 12 reaches a position of maximum opening in order to permit the exhaust gases to pass into the port 2 at a maximum rate of flow. The control of the degree of opening of the proportioning flap 12 is thus performed by pivoting said proportioning flap 12 that is controlled by the actuating wheel 16, while the diverter flap 10 remains in a closed position of the port 11. At any moment, the actuating wheel 16 may be set in rotation in the opposite direction in order to adjust the opening position of the proportioning flap 12 by reducing the rate of flow of the gases into the port 2.

The position of maximum opening of the proportioning flap 12 is reached when the flap 12 reaches an angular position of 75°. This position is reached, for example, when the actuating wheel 16 comes into abutment against an end stop (not illustrated here).

The actuating wheel 16 may likewise be set in rotation in the direction opposite the direction indicated by the arrow 23 in FIGS. 6, 8 and 10.

If the diverter flap is in the closed position of the port 11, for example as in the position E illustrated in FIGS. 10 and 11, a rotation of the actuating wheel 16 in the direction opposite the direction indicated by the arrow 23 imparts a rotation to the drive pin 32 and the lever 24. The drive pin thus rotates in the direction allowing it to return into the groove 28. The lever 24 causes the displacement of the lever 22. The first inner edge of the cavity 62 thus exerts a pressure on the pin 63 that is lower than the pressure exerted by the return spring on the proportioning flap 12. Consequently, the flap 12 is actuated by the return spring 18 in order to reduce the cross section for the passage of the gases in the port 2.

The rotation of the actuating wheel 16 may continue in the same direction of rotation, in such a way that the proportioning flap 12 closes the port 2. The unit then arrives in position C. As the actuating wheel 16 continues to rotate in the same direction, the drive pin 32 enters into the groove 28 and causes the interface component 26, and thus the diverter flap 10 which is integral with it, to be set in rotation by exerting a pressure on one of the two arms 27 bordering the groove 28. The pin 63 slides in the cavity 62, given that the proportioning flap 12 is maintained in the closed position of the port 2 by the return spring 18 and that the lever 22 continues its displacement. The rotation of the actuating wheel 16 may continue in the same direction of rotation, in such a way that the proportioning flap 12 closes the port 2 and the diverter flap 10 opens the ports 9 and 11 to the maximum extent. The unit then arrives in the resting position A in FIGS. 4 and 5.

All that has been described until now in respect of the pivoting cinematic of the diverter flap 10 for closing the port 11 remains equally valid when said flap 10 closes the port 9, that is to say when the actuating wheel 16 turns in the opposite direction to that of the arrow 23 in FIG. 6 while the unit 1 is in the resting position. The pivoting cinematic of the proportioning flap 12 remains equally valid.

We will now describe a sensor 110 capable of measuring an angular position of the actuating device 15 in such a way as to permit the control of the valve 100, as can be seen in FIG. 1.

Said sensor 110 is capable of measuring this angular position:
with a first high sensitivity HR1 when the angular position is in a range of high sensitivity P1,
with a low sensitivity LR when the angular position is in a range of low sensitivity P2,
with a second high sensitivity HR2 when the angular position is in a second range of high sensitivity P3, the sensitivities HR1 and HR2 being greater than LR.

In the example described here, as may be appreciated from FIG. 2:
The first range of high sensitivity P1 extends from position F1 of the actuating device as far as position F2.
The second range of high sensitivity P3 extends from position F3 of the actuating device as far as position F4.
The range of low sensitivity P2 extends from position F2 of the actuating device as far as position F3, this range of low sensitivity being between the two ranges of high sensitivity, in other words the ranges of high sensitivity are situated to either side of the range of low sensitivity.

In the example described, position F1 corresponds to the angle of the actuating device 15 for which, at the same time, the metering means 12 is in the position of maximum opening of the port 2 and the diverting means 10 is in the closed position of the port 9. The fluid then flows into the port 11.

Position F2 corresponds to the angle of the actuating device 15 for which the metering means 12 reaches the closed position of the port 2, the diverting means 10 being in the closed position of the port 9.

Position F3 corresponds to the angle of the actuating device 15 for which the diverting means 10 begins to open the port 2, the diverting means being in the closed position of the port 11.

Position F4 correspond to the angle of the actuating device 15 for which, at the same time, the metering means 12 is in the position of maximum opening of the port 2 and the diverting means is in the closed position of the port 11. The fluid then flows into the port 9.

In order to determine with precision the position of points F2 and F3, one may proceed in the following manner: when the driving wheel is in position A, for which the proportioning flap is completely closed and the diverter flap does not close either of the 2 ports, the proportioning flap is locked in its closed position, by means of tooling pressing on the flap, although said tooling is not described in the figures. The actuating device is then controlled in one direction, for example in the positive direction of measurement of the angle of the actuating device 15. The latter will thus be able to turn as far as the position in which the proportioning flap would start to pivot if it was not being locked in position by the tooling. The position obtained corresponds to point F3. At this moment, the sensor is calibrated in order to ensure that its output signal is equal to V3.

The calibration of the sensor is a functionality that is incorporated in the majority of commercially available sensors, which permits the user to set the level of the signal at a selected level, for a certain number of positions, for example four.

The actuating device is then controlled in the other direction, that is to say in the negative direction of measurement of the angle of the actuating device 15. As described above, this will be able to turn as far as the position in which the proportioning flap would begin to pivot if it was not being locked in position by the tooling. The position obtained corresponds to point F2. The sensor is then calibrated in order to ensure that its output signal is equal to V2.

The tooling which permits the locking of the proportioning flap is then removed in order to ensure that the proportioning flap is able to pivot normally. The precise position of points F1 and F4 can then be determined in the following manner:

The actuating device is then controlled in the positive direction of measurement of the angle, as far as the maximum accessible value, corresponding to the first mechanical stop. The position obtained corresponds to position F4, the proportioning flap then being fully open and the diverter flap then closing the port 11. The sensor is then calibrated in order to ensure that its output signal is equal to V4.

Finally, the actuating device is controlled in the negative direction of measuring the angle, as far as the minimum accessible value, corresponding to the second mechanical stop. The position obtained corresponds to the position F1, the proportioning flap then being fully open and the diverter flap then closing the port 9. The sensor is then calibrated in order to ensure that its output signal is equal to V1.

This procedure may be performed in an individual manner on all the manufactured parts. The values V1, V2, V3, V4 are constant between one produced part and the other.

Thus, even if the dimensional variations between the parts, which are inevitable in large-scale mass production, cause a variation in the angular position of the points F1, F2, F3, F4, the output voltage produced by the sensor for each of these positions, will always be identical. The precision of regulation of the rate of flow is improved in relation to a valve in which the variation in the positions F1, F2, F3, F4 would not be taken into consideration.

FIG. 12 compares the response curves of a sensor according to the prior art and of the sensor 110. The two curves C1 and C2 plot the output voltage supplied by the sensors depending on the angle of rotation of the actuating device 15. The sensitivity of the sensor is demonstrated by the slope of the voltage curve depending on the angle of the actuating device.

The curve C1 drawn as a broken line depicts a sensor that is familiar from the prior art, for which the sensitivity is constant regardless of the angular range. As a consequence, the response curve of the output voltage depending on the angle of rotation is a straight line.

In the case of the curve C2 drawn as a solid line, the sensitivity depends on the angular range. In this example, it is possible to see 2 ranges of high sensitivity P1, P3 and one range of low sensitivity P2.

The range P3 is wider than the range P2, which is itself wider than the range P1. Of the 2 zones of high sensitivity described here, the value of the sensitivity is higher in the range P3 than in the range P2.

In the interior of each of the ranges P1, P2, P3, the signal follows a linear path. The response curve of the voltage depending on the angle is formed from three line segments.

Thus, the variation in the voltage in the range P1 is greater on the curve C2 in relation to the curve C1. As a consequence, the variations in the angular position in this range may be measured with greater accuracy.

The same is true in the range P3.

By contrast, the variation in the voltage in the angular range P2, in which the diverting means pass from one closed position to another, is significantly reduced in relation to the curve C1, which is characteristic of a sensor of constant sensitivity. The variations in the angular position in this range are measured with less accuracy, although this situation does not give rise to any disadvantage because the need for precision is low in this zone.

The response curve of the position sensor places emphasis on the zones where the need for precision is most important in order to ensure effective control of the fluid control unit described.

In total, the rotation of the actuating means between points F1 and F4 takes place over practically 360 degrees.

The ratio between the value of one of the high sensitivities and the value of the low sensitivity has a minimum value of 2, in order to obtain a significant advantage. A ratio at least equal to 4 should preferably be used.

The example in FIG. 12 describes a sensor of the analog type, supplying a voltage depending on the angle to be measured. The same principle may apply to a sensor of the digital type, that is to say supplying digital information coded on a certain number of bits. In this case, the analog signal receives the treatment described above before being transformed by the analog/digital conversion stage of the sensor.

1. A sensor for a component of a motor vehicle, said sensor being capable of measuring a physical property of a component:
with a first sensitivity when the physical property is in a range of high sensitivity,
with a second sensitivity when the physical property is in a range of low sensitivity, the first sensitivity being greater than the second sensitivity.

2. The sensor according to claim 1, wherein the sensor is arranged to generate two ranges of high sensitivity and one range of low sensitivity.

3. The sensor according to claim 2, wherein the ranges of high sensitivity are to either side of the range of low sensitivity.

4. The sensor according to claim 1, wherein the value of the high sensitivity is at least two times, and in particular at least four times higher than that of the low sensitivity.

5. The sensor according to claim 1, wherein the sensor is arranged to deliver a signal of the analog type.

6. The sensor according to claim 1, wherein the sensor is arranged to produce signals of the digital type.

7. The sensor according to claim 1, wherein the physical property measured by the sensor is a position of an actuating device.

8. The sensor according to claim 1, wherein the physical property measured by the sensor is an angular position.

9. A fluid control unit for a valve having at least three ports for a motor vehicle, the fluid control unit comprising:
a mobile metering means arranged for the selective opening or closing of a first of the three ports;
a mobile diverting means arranged for the selective closing of a second or a third of the three ports; and
an actuating device for the two means
at least one sensor capable of measuring a physical property of the actuating device:
with a first sensitivity when the physical property is in a range of high sensitivity,
with a second sensitivity when the physical property is in a range of low sensitivity, the first sensitivity being greater than the second sensitivity.

10. A unit according to claim 9, including first and second ranges of high sensitivity, wherein:
the first range of high sensitivity extends from the position of the actuating device corresponding to the position of maximum opening of the metering means, as far as the position corresponding to the closed position of the metering means, the diverting means being stationary in this range and closing the second port,
the second range of high sensitivity extends from the position of the actuating device corresponding to the closed position of the metering means as far as the position corresponding to the position of maximum opening of the metering means, the diverting means being stationary in this range and closing the third port,
the range of low sensitivity extends from the position of the actuating device as far as the position, the metering means being in the closed position of the first port in this range and the diverting means passing from the closed position of the second port to the closed position of the third port.

11. The unit according to claim 10, the actuating device including at least one rotatably mounted actuating wheel for the joint actuation of the metering means and of the diverting means.

12. A valve including the fluid control unit according to claim 9.

13. A method for the measurement of a physical property of a component, said method including the following stages:
measuring the physical property with a first sensitivity when the physical property is in a range of high sensitivity; and
measuring the physical property with a second sensitivity when the physical property is in a range of low sensitivity, the first sensitivity being greater than the second sensitivity.

14. The method according to claim 13, wherein the measured physical property is an angular position of a valve.

15. The method according to claim 13, wherein an individual calibration of the characterizing features of the sensor is performed in order to ensure that the voltage produced for each of the positions corresponding to one extreme of the different defined ranges of sensitivity is constant.
